(19) United States
(12) Patent Application Publication
(10) Pub. No.: US 2016/0113434 A1
(43) Pub. Date: Apr. 28, 2016

(54) POT AND INFUSER THEREOF

(71) Applicant: NINGBO ISMAL HIGH-TECH ELECTRICS CO. LTD, Yuyao (CN)

(72) Inventors: Yuejun DONG, Yuyao (CN); Yingli YU, Yuyao (CN)

(21) Appl. No.: 14/713,431

(22) Filed: May 15, 2015

(30) Foreign Application Priority Data
Oct. 27, 2014 (CN) 201420629603.3

(51) Int. Cl. A47J 31/06

(52) U.S. Cl. CPC A47J 31/0636

(57) ABSTRACT

A pot and an infuser thereof are disclosed. The infuser comprises a lifting button, an upper rod, a lower rod and a basket. The basket is connected to the lower rod. The bottom end of the upper rod is hinged to the top end of the lower rod. The lifting button is connected to the top end of the upper rod. The present disclosure enables the separation of the infusion from the water conveniently.

### TECHNICAL FIELD

The present disclosure relates to a technical field of household goods, and more particularly, to an infuser and a pot with the infuser.

### BACKGROUND

A pot such as an electric pot is usually provided with a basket (for example, a tea basket) in a pot body in order to collect and remove an infusion such as tea leaves when the pot is used to infuse the infusion.

In a conventional pot such as a conventional electric pot, however, the basket is typically provided only at a fixed position in the pot body. Due to the relatively fixed position, the basket is not allowed to be lifted up and down. It is inconvenient for the user to take the basket out of the pot body. Further, the pot is not limited to infuse the infusion such as tea leaves, but sometimes the pot is used to boil water or milk and the like. Thus, there are some situations in which for example the infusion such as tea leaves shall be separated from the water when the user uses the pot, or for example the basket is desired to be separated from the water inside the pot when only the boiled water is needed; there are also some situations in which the basket needs to be taken out from the pot body, for example, when the user wants to clean the basket or boil milk by means of the pot.

The arrangement of the conventional basket may cause a significant inconvenience to the user in the above situations.

Accordingly, it is necessary to develop a connection structure for the basket, which is capable of achieving the separation of the infusion from the water more conveniently, so as to improve the use convenience.

### SUMMARY

To solve the existing problem in the related art, an objective of the present disclosure is to provide an infuser for allowing an infusion to be separated from the water conveniently, so as to improve the user's convenience.

Another objective of the present disclosure is to provide a pot having an infuser according to the present disclosure.

To achieve the above objectives, technical solutions of the present disclosure are as follows.

In one aspect of the disclosure, an infuser may include a lifting button, an upper rod, a lower rod and a basket. The basket may be connected to the lower rod, the bottom end of the upper rod is hinged to the top end of the lower rod, and the lifting button is connected to the top end of the upper rod.

In an embodiment of the infuser according to the present disclosure, the lifting button may be detachably connected to the top end of the upper rod.

In an embodiment of the infuser according to the present disclosure, the lifting button may have a button projection extending downwards from the bottom surface thereof; the upper rod may have a cylinder portion on the top end of the lifting button; the button projection may be detachably connected to the cylinder portion; the button projection may have a threaded hole; and the cylinder portion may have an outer thread for engaging with the inner thread in the threaded hole.

In an embodiment of the infuser according to the present disclosure, the upper rod may have a length larger than that of the lower rod.

In an embodiment of the infuser according to the present disclosure, the button projection, the upper rod and the lower rod all may be cylindrical, the upper rod may have a diameter equal to that of the lower rod, and the button projection may have a diameter larger than that of the upper rod.

In another aspect of the disclosure, a pot may include a pot body, a pot cover and an infuser according to the present disclosure. An opening, through which the upper rod passes, may be provided on the pot cover.

In an embodiment of the pot according to the present disclosure, the opening may be a cylindrical hole, and may have a diameter larger than that of the upper rod.

In an embodiment of the pot according to the present disclosure, the opening may be positioned at the geometric center of the pot cover.

In an embodiment of the pot according to the present disclosure, the upper rod may have a length larger than the radius of the pot cover.

In an embodiment of the pot according to the present disclosure, the pot may be an electric pot.

The present disclosure has the following advantageous effects: the infuser and the pot according to the present disclosure are simple in structure and manufactured with low cost, and enable the separation of the infusion from the water (or the separation of the basket from the water) more conveniently. In the condition that the user wants to separate the infusion from the water, or to take the basket out of the pot, the user can operate simply and conveniently, and the convenience in use is improved.

### BRIEF DESCRIPTION OF THE DRAWINGS

FIG. 1 is a schematic diagram of a pot and its infuser according to the present disclosure.

FIG. 2 is a schematic diagram of the basket of the infuser according to the present disclosure in a lifted state.

FIG. 3 is a schematic diagram of the infuser according to the present disclosure in a state that the infusion and the water are separated.

FIG. 4 is a schematic diagram of the infuser according to the present disclosure when a lifting button has been screwed out.

FIG. 5 is a schematic diagram of the infuser according to the present disclosure when a lifting button has been removed.

FIG. 6 is a schematic diagram of the lifting button of the pot according to the present disclosure when the lifting button is covered onto the pot.

### DETAILED DESCRIPTION

Exemplary embodiments indicating the characteristics and advantages of the present disclosure are described in detail in the following explanation. It should be understood that various variations and modifications can be made to the disclosure without departing from the spirit and the scope of this disclosure, and also, the explanation and the drawings thereof are illustrative, and are not intended to limit the present disclosure.

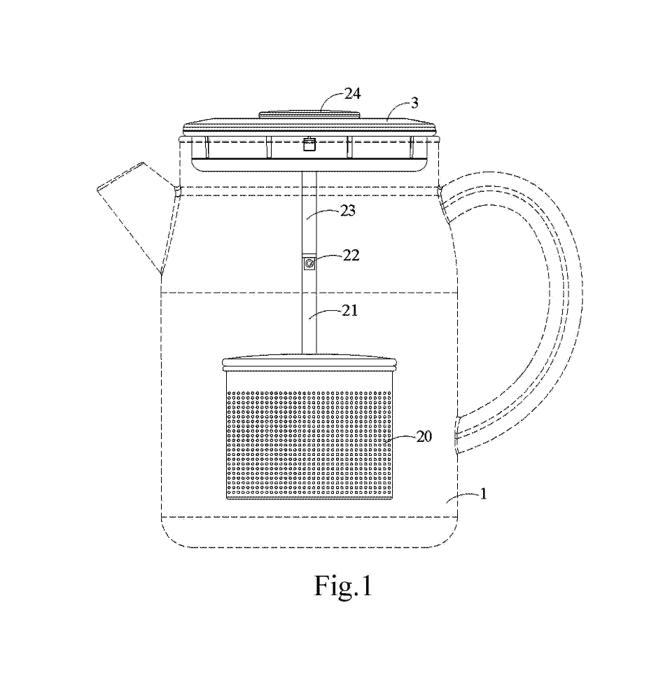

As shown in FIGS. 1-3, a pot 1 according to an embodiment of the present disclosure has an infuser according to the present disclosure.

The pot according to the present disclosure may be an electric pot.

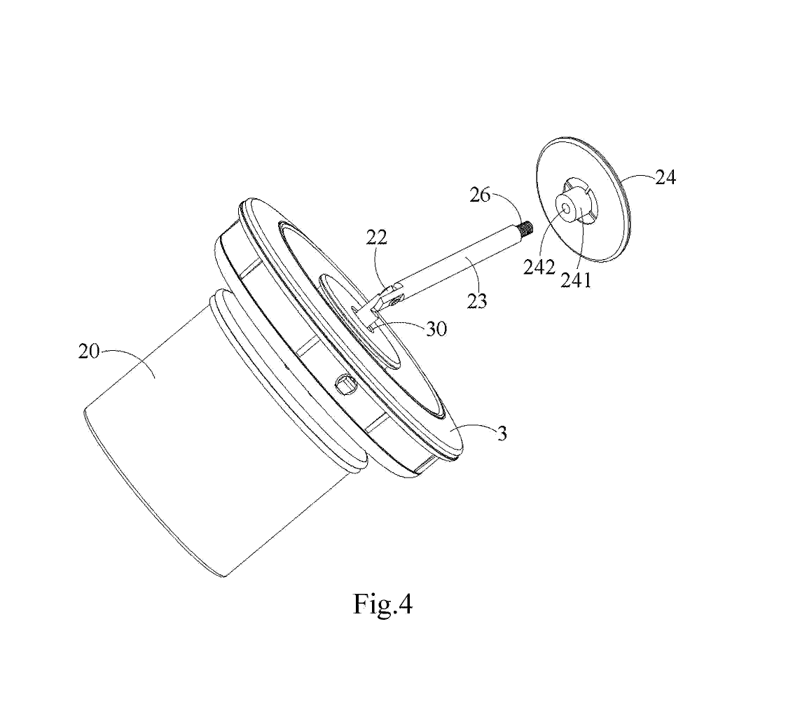

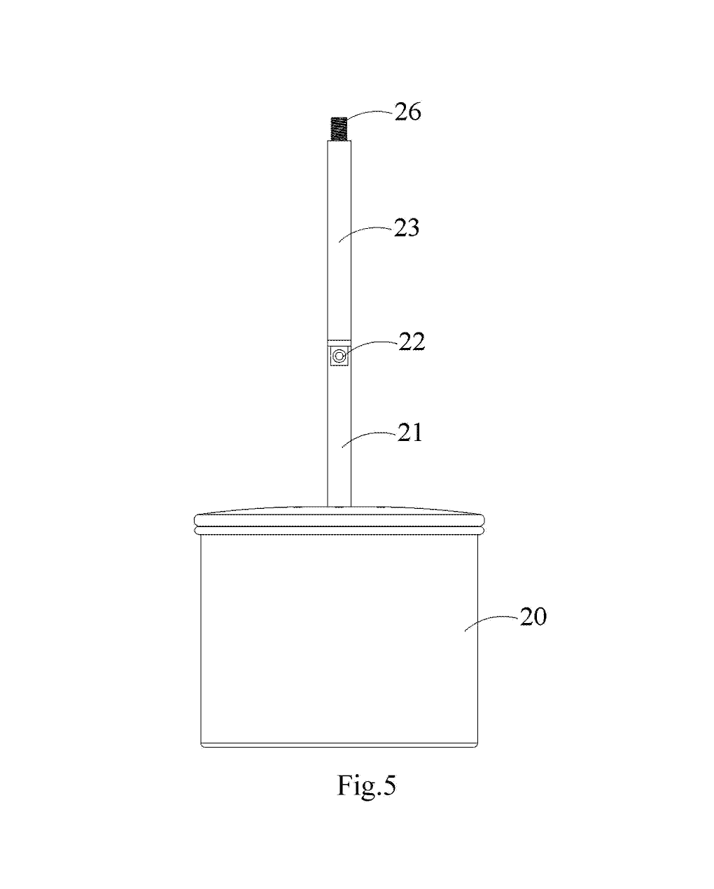

As shown in FIGS. 4 and 5, the infuser according to the present disclosure includes a lifting button 24, an upper rod 23, a lower rod 21 and a basket 20. Wherein the basket 20 is connected to the lower rod 21, for example to the bottom end of the lower rod 21; the bottom end of the upper rod 23 is hinged to the top end of the lower rod 21 through a hinge 22; and the lifting button 24 is detachably connected to the top end of the upper rod 23.

The basket 20 is normally hung inside the pot body (infusion container) of the pot 1. The basket 20 has a plurality of small holes on its circumferential wall. In the infused state, water may enter the basket 20 and an infusion (such as tea leaves) is immerged in the water without leaving from the inner of the basket 20, such that the infusion is prevented from getting into a space in the pot body out of the basket when pouring water.

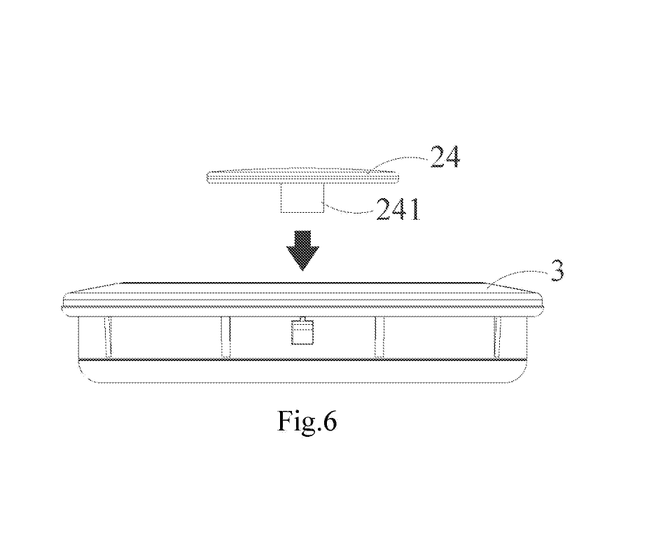

As shown in FIGS. 4 and 6, the lifting button 24 has a button projection 241 extending downwards from its bottom surface. Correspondingly, the upper rod 23, on its top end, has a cylindrical portion 26, to which the button projection 241 is detachably connected. More particularly, the button projection 241 has a threaded hole 242 with an inner thread, while the cylindrical portion 26 has an outer thread for engaging with the inner thread of the threaded hole 242. The button projection 241 is detachably connected to the cylindrical potion 26 through the thread engagement between the inner and outer threads.

As shown in FIG. 5, the upper rod 23 may have a length larger than that of the lower rod 21, such that the basket 20 may be lifted as high as possible to enable the separation of the infusion from the water effectively. Furthermore, each of the button projection 241, the upper rod 23 and the lower rod 21 may be cylindrical. However, the present disclosure is not limited to this, and other shapes may be used, such as a quadrangular prism and the like. In the case that the button projection 241, the upper rod 23 and the lower rod 21 are all cylindrical, the upper rod 23 may have a diameter equal to that of the lower rod 21, while the button projection 241 may have a diameter larger than that of the upper rod 23.

As shown in FIG. 1, the pot 1 according to the present disclosure includes a pot body and a pot cover 3 with an opening 30 therein, through which the button projection 241 or the upper rod 23 passes. The button projection 241 or the upper rod 23 passes through the opening 30, such that the basket 20 may be relatively fixed, which is helpful to the infusion immersion. In addition, in the case that the user desires to separate the infusion from the water or remove the basket 20 from the pot, the upper rod 23 and the lower rod 21 may be slid in the opening 30. For example, the opening 30 may have a shape matching with the shapes of the upper rod 23, the lower rod 21 and the button projection 241. In the case that the upper rod 23, the lower rod 21 and the button projection 241 are all cylindrical, the opening 30 may be cylindrical as well. However, the present disclosure is not limited to this. To facilitate the sliding of the upper rod 23 and the lower rod 21, the opening 30 has a diameter larger than that of the upper rod 23. Furthermore, the opening 30 is positioned for example at the geometric center of the pot cover 3, for example, the opening 30 will be positioned at the center of the circle if the pot cover 3 is circular.

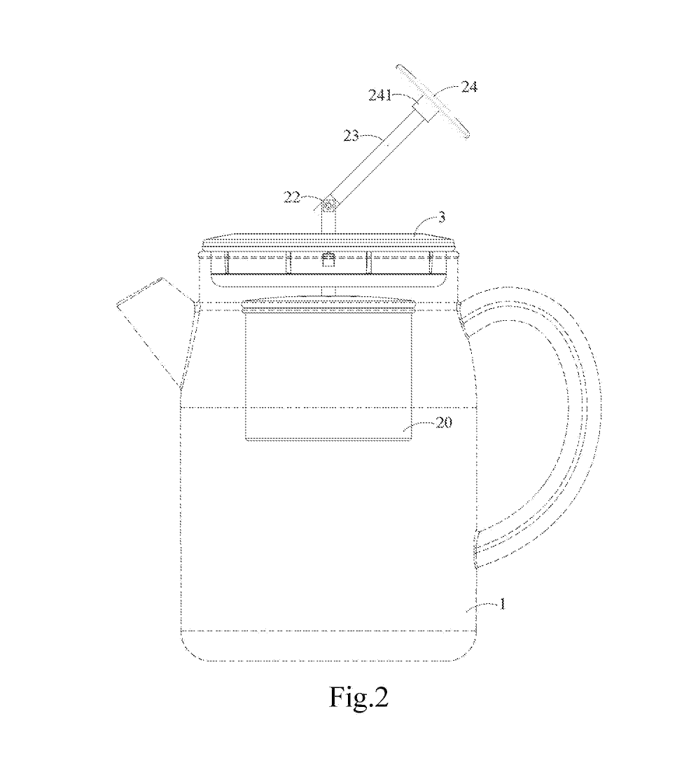

When the user desires to separate the infusion from the water, the user may grip the lifting button 24 and lift the infuser according to the present disclosure. When lifting the infuser, the upper rod 23 and lower rod 21 should keep uprightly, before the hinge 22 passes the upper edge of the opening 30. The separation of the infusion from the water is achieved, when the hinge 22 passes the upper edge of the opening 30, as shown in FIG. 2.

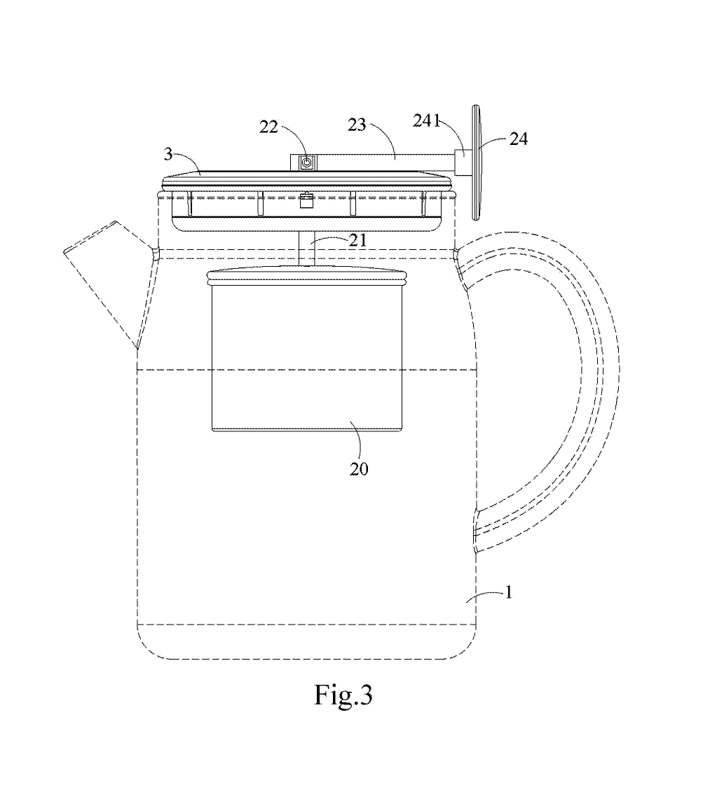

Furthermore, in the state that the infusion and the water have been separated, as shown in FIG. 3, the upper rod 23 may be lay horizontally on the pot cover 3 to allow the pot 1 to be easily used. In such a state, the lower rod 21 is arranged in the opening 30, which requires the length of the upper rod 23 larger than the radius of the pot cover 3.

If the user desires to take the basket 20 out of the pot body, the user may pick up the pot cover 3, and screw in or out the lifting button 24 due to the thread connection between the upper rod 23 and the lifting button 24, such that the basket 20 can be removed from the cover 3 when the basket 20 is not used. After removing the infuser from the pot cover 3, the lifting button 24 may be covered onto the pot cover 3. To do this, the button projection 241 of the lifting button 24 should be inserted into the opening 30 to prevent the steam from escaping from the opening 30 of the pot cover 3 during boiling water. In this case, in order to ensure that the lifting button 24 is conveniently covered onto the pot cover 3 and then ensure the tightness of the pot cover 3, it is desired that an inner diameter of the opening 30 is substantially equal to or slightly larger than the out diameter of the button projection 241.

It will be appreciated by those skilled in the art that modifications and variations can be made without departing from the scope and spirit disclosed by the appended claims of the present disclosure, and such modifications and variations all fall in the protection extent of the claims of the present disclosure.

1. An infuser comprising a lifting button, an upper rod, a lower rod and a basket, wherein:
the basket is connected to the lower rod;
the upper rod includes a bottom end being hinged to a top end of the lower rod, and a top end being connected to the lifting button.

2. The infuser according to claim 1, wherein the lifting button is detachably connected to the top end of the upper rod.

3. The infuser according to claim 1, wherein a button projection extending downwards from a bottom surface of the lifting button is provided; a cylinder portion is provided on the top end of the upper rod; the button projection is detachably connected to the cylinder portion; the button projection has a threaded hole; and the cylinder portion has an outer thread for engaging with an inner thread in the threaded hole.

4. The infuser according to claim 1, wherein the upper rod has a length larger than that of the lower rod.

5. The infuser according to claim 3, wherein the button projection, the upper rod and the lower rod are cylindrical; the upper rod has a diameter equal to that of the lower rod; and the button projection has a diameter larger than that of the upper rod.

6. A pot comprising a pot body, a pot cover and an infuser according to claim 1, an opening, through which the upper rod passes, being provided on the pot cover.

7. The pot according to claim 6, wherein the opening is a cylindrical hole and has a diameter larger than that of the upper rod.

8. The pot according to claim 7, wherein the opening is positioned at the geometric center of the pot cover.

9. The pot according to claim 6, wherein the upper rod has a length larger than the radius of the pot cover.

10. The pot according to claim 6, wherein the pot is an electric pot.
